(19) United States
(12) Patent Application Publication
(10) Pub. No.: US 2024/0153696 A1
(43) Pub. Date: May 9, 2024

(54) COIL COMPONENT AND METHOD OF MANUFACTURING COIL COMPONENT

(71) Applicant: TDK CORPORATION, Tokyo (JP)

(72) Inventors: Takuya TAKEUCHI, Tokyo (JP); Nobuyuki OKUZAWA, Tokyo (JP); Nobuya TAKAHASHI, Tokyo (JP)

(73) Assignee: TDK CORPORATION, Tokyo (JP)

(21) Appl. No.: 18/499,509

(22) Filed: Nov. 1, 2023

(30) Foreign Application Priority Data
Nov. 4, 2022 (JP) 2022-177113

(51) Int. Cl. H01F 27/29; H01F 27/32; H01F 41/04

(52) U.S. Cl. CPC H01F 27/292; H01F 27/324; H01F 41/041

(57) ABSTRACT

A coil component includes an element body, a pair of terminal electrodes, and a coil. The coil includes a first wiring portion, a second wiring portion, and a connection portion. A plurality of insulating layers includes a first insulating layer constituting a principal surface, the first insulating layer including the principal surface and a facing surface facing the principal surface, the first wiring portion being disposed along the facing surface, a second insulating layer constituting a mounting surface, and one or a plurality of third insulating layers disposed between the first insulating layer and the second insulating layer. A surface roughness of the facing surface of the first insulating layer is smaller than a surface roughness of each of surfaces of the second insulating layer and the third insulating layer.

### TECHNICAL FIELD

The present disclosure relates to a coil component and a method of manufacturing the coil component.

### BACKGROUND

Patent Document 1 (Japanese Unexamined Patent Publication No. 2015-141945) discloses a coil component including an insulator made of resin, a coil-shaped internal conductor provided in the insulator, and a terminal electrode electrically connected to the internal conductor and disposed on a mounting surface of an element body.

### SUMMARY

In the present disclosure, a coil component capable of improving frequency characteristics and a method of manufacturing the coil component will be described.

A coil component according to one aspect of the present disclosure includes: an element body formed by laminating a plurality of insulating layers, the element body including a mounting surface and a principal surface facing the mounting surface; a pair of terminal electrodes disposed on the mounting surface of the element body; and a coil disposed in the element body and electrically connected to the pair of terminal electrodes, in which the coil includes a first wiring portion disposed on a side of the principal surface, a second wiring portion disposed on a side of the mounting surface, and a connection portion extending in a facing direction of the mounting surface and the principal surface and connecting the first wiring portion and the second wiring portion, the plurality of insulating layers includes a first insulating layer constituting the principal surface, the first insulating layer including the principal surface and a facing surface facing the principal surface, the first wiring portion being disposed along the facing surface, a second insulating layer constituting the mounting surface, and one or a plurality of third insulating layers disposed between the first insulating layer and the second insulating layer, and a surface roughness of the facing surface of the first insulating layer is smaller than a surface roughness of each of surfaces of the second insulating layer and the third insulating layer.

In a method of manufacturing a coil component according to one aspect of the present disclosure, the coil component including: an element body formed by laminating a plurality of insulating layers, the element body including a mounting surface and a principal surface facing the mounting surface; a pair of terminal electrodes disposed on the mounting surface of the element body; and a coil disposed in the element body and electrically connected to the pair of terminal electrodes, in which the coil includes a first wiring portion disposed on a side of the principal surface, a second wiring portion disposed on a side of the mounting surface, and a connection portion extending in a facing direction of the mounting surface and the principal surface and connecting the first wiring portion and the second wiring portion, and the plurality of insulating layers includes a first insulating layer constituting the principal surface, the first insulating layer including the principal surface and a facing surface facing the principal surface, the first wiring portion being disposed along the facing surface, a second insulating layer constituting the mounting surface, and one or a plurality of third insulating layers disposed between the first insulating layer and the second insulating layer, the method including making a surface roughness of the facing surface of the first insulating layer smaller than a surface roughness of each of surfaces of the second insulating layer and the third insulating layer.

According to each aspect and each embodiment of the present disclosure, a coil component capable of improving frequency characteristics and a method of manufacturing the coil component are provided.

### BRIEF DESCRIPTION OF THE DRAWINGS

FIG. 1 is a perspective view of a coil component according to an embodiment;

FIG. 2 is a view of the coil component illustrated in FIG. 1 as viewed from an end surface side;

FIG. 3 is a diagram illustrating a configuration of an element body; and

FIG. 4 is a diagram illustrating an example of a method of forming a polished surface.

### DETAILED DESCRIPTION

### [1] Summary of Embodiment

(1) A coil component according to one aspect of the present disclosure includes: an element body formed by laminating a plurality of insulating layers, the element body including a mounting surface and a principal surface facing the mounting surface; a pair of terminal electrodes disposed on the mounting surface of the element body; and a coil disposed in the element body and electrically connected to the pair of terminal electrodes, in which the coil includes a first wiring portion disposed on a side of the principal surface, a second wiring portion disposed on a side of the mounting surface, and a connection portion extending in a facing direction of the mounting surface and the principal surface and connecting the first wiring portion and the second wiring portion, the plurality of insulating layers includes a first insulating layer constituting the principal surface, the first insulating layer including the principal surface and a facing surface facing the principal surface, the first wiring portion being disposed along the facing surface, a second insulating layer constituting the mounting surface, and one or a plurality of third insulating layers disposed between the first insulating layer and the second insulating layer, and a surface roughness of the facing surface of the first insulating layer is smaller than a surface roughness of each of surfaces of the second insulating layer and the third insulating layer.

In the coil component according to one aspect of the present disclosure, the surface roughness of the facing surface of the first insulating layer is smaller than the surface roughness of each of the surfaces of the second insulating layer and the third insulating layer. On the facing surface, the first wiring portion is disposed along the facing surface. As a result, in the coil component, a surface (a surface in contact with the facing surface) of the first wiring portion can be made flat (unevenness can be reduced). Accordingly, in the coil component, the resistance in the first wiring portion can be reduced. Therefore, in the coil component, characteristics in a high frequency band can be improved. In particular, by planarizing the surface of the first wiring portion disposed at a position away from the mounting surface on which the terminal electrodes are disposed, the influence of a stray capacitance formed between the first wiring portion and the terminal electrodes is small, so that the characteristics can be effectively improved. As described above, in the coil component, the frequency characteristics can be improved.

(2) In the coil component of (1) described above, the surface

roughness of the facing surface of the first insulating layer may be smaller than a surface roughness of the mounting surface of the second insulating layer. In other words, the surface roughness of the mounting surface of the second insulating layer is larger than the surface roughness of the facing surface of the first insulating layer. In this configuration, since the unevenness is formed on the mounting surface on which the terminal electrodes are disposed, the joint strength between the element body and the terminal electrodes can be improved by the anchor effect. Therefore, peeling of the terminal electrodes can be suppressed.

(3) In the coil component of (1) or (2) described above, a thickness of the first insulating layer in the facing direction of the mounting surface and the principal surface may be thinner than a thickness of the second insulating layer. In this configuration, a height of the coil component can be reduced. Furthermore, by making the thickness of the second insulating layer constituting the mounting surface on which the terminal electrodes are disposed thicker than the thickness of the first insulating layer, a stray capacitance formed between the terminal electrodes and the second wiring portion can be reduced.

(4) In the coil component according to any one of (1) to (3) described above, the second insulating layer may include a resin and a filler, the mounting surface may be a polished surface formed by polishing, and the filler may be exposed on at least a part of the mounting surface. As described above, in the configuration in which the filler is exposed on the mounting surface, a part of the filler may fall off at the time of polishing, and a recess may be formed on the mounting surface. As described above, since the recess is formed on the mounting surface by polishing, the surface of the mounting surface can be roughened. Therefore, the joint strength between the element body and the terminal electrodes can be improved by the anchor effect.

(5) In a method of manufacturing a coil component according to one aspect of the present disclosure, the coil component includes: an element body formed by laminating a plurality of insulating layers, the element body including a mounting surface and a principal surface facing the mounting surface; a pair of terminal electrodes disposed on the mounting surface of the element body; and a coil disposed in the element body and electrically connected to the pair of terminal electrodes,
in which the coil includes a first wiring portion disposed on a side of the principal surface, a second wiring portion disposed on a side of the mounting surface, and a connection portion extending in a facing direction of the mounting surface and the principal surface and connecting the first wiring portion and the second wiring portion, and the plurality of insulating layers includes a first insulating layer constituting the principal surface, the first insulating layer including the principal surface and a facing surface facing the principal surface, the first wiring portion being disposed along the facing surface, a second insulating layer constituting the mounting surface, and one or a plurality of third insulating layers disposed between the first insulating layer and the second insulating layer, the method including making a surface roughness of the facing surface of the first insulating layer smaller than a surface roughness of each of surfaces of the second insulating layer and the third insulating layer.

In the method of manufacturing a coil component according to one aspect of the present disclosure, the surface roughness of the facing surface of the first insulating layer is made smaller than the surface roughness of each of the surfaces of the second insulating layer and the third insulating layer. On the facing surface, the first wiring portion is disposed along the facing surface. Thus, in the coil component manufactured by the method of manufacturing a coil component, a surface (a surface in contact with the facing surface) of the first wiring portion can be made flat (unevenness can be reduced). Accordingly, in the coil component, the resistance in the first wiring portion can be reduced. Therefore, in the coil component, characteristics in a high frequency band can be improved. In particular, by planarizing the surface of the first wiring portion disposed at a position away from the mounting surface on which the terminal electrodes are disposed, the influence of a stray capacitance formed between the first wiring portion and the terminal electrodes is small, so that the characteristics can be effectively improved. As described above, in the method of manufacturing the coil component, the frequency characteristics can be improved.

### [2] Exemplification of Embodiment

Hereinafter, an embodiment of the present disclosure will be described in detail with reference to the drawings. Note that in the description of the drawings, the same elements are denoted by the same reference signs, and redundant description is omitted.

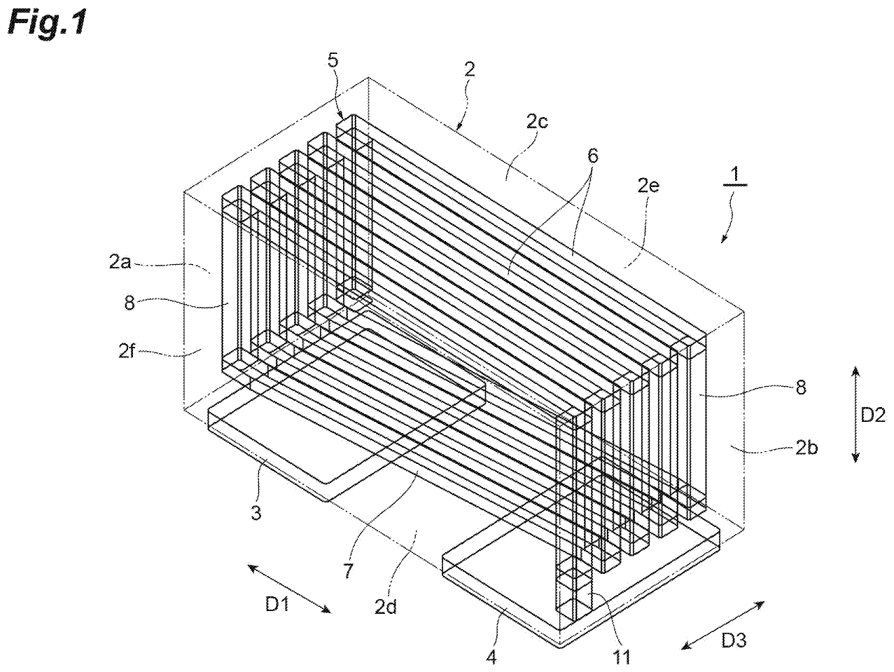

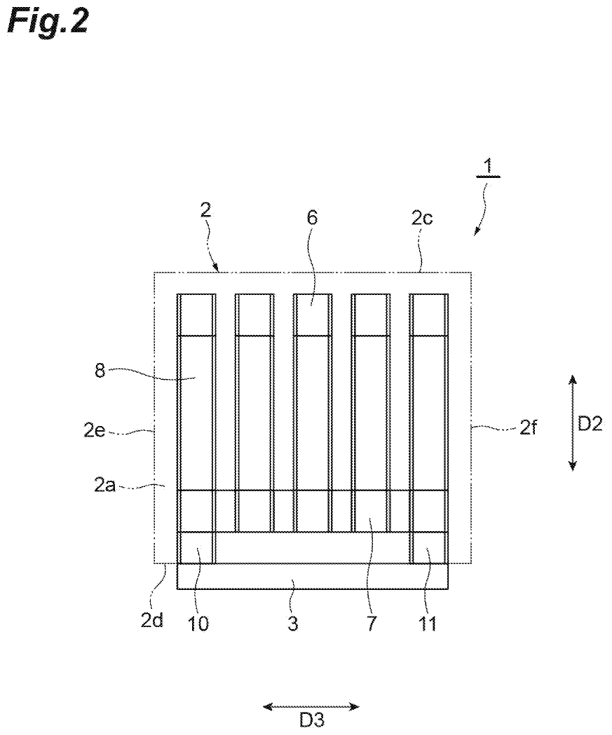

A coil component according to the present embodiment will be described with reference to FIG. 1. FIG. 1 is a perspective view of a coil component according to an embodiment. As illustrated in FIG. 1, a coil component 1 includes an element body 2, a first terminal electrode 3 and a second terminal electrode 4, a coil 5, a first connection conductor 10 (see FIG. 2), and a second connection conductor 11.

The element body 2 has a rectangular parallelepiped shape. The rectangular parallelepiped shape includes a rectangular parallelepiped shape in which corners and ridges are chamfered, and a rectangular parallelepiped shape in which corners and ridges are rounded. The element body 2 includes a pair of end surfaces 2a and 2b, a pair of principal surfaces 2c and 2d, and a pair of side surfaces 2e and 2f as outer surfaces. The end surfaces 2a and 2b face each other. The principal surfaces 2c and 2d face each other. The side surfaces 2e and 2f face each other. Hereinafter, a facing direction of the end surfaces 2a and 2b is referred to as a first direction D1, a facing direction of the principal surfaces 2c and 2d is referred to as a second direction D2, and a facing direction of the side surfaces 2e and 2f is referred to as a third direction D3. The first direction D1, the second direction D2, and the third direction D3 are substantially orthogonal to each other.

The end surfaces 2a and 2b extend in the second direction D2 so as to connect the principal surfaces 2c and 2d. The end surfaces 2a and 2b also extend in the third direction D3 so as to connect the side surfaces 2e and 2f. The principal surfaces 2c and 2d extend in the first direction D1 so as to connect the end surfaces 2a and 2b. The principal surfaces 2c and 2d also extend in the third direction D3 so as to connect the side surfaces 2e and 2f. The side surfaces 2e and 2f extend in the first direction D1 so as to connect the end surfaces 2a and 2b. The side surfaces 2e and 2f also extend in the second direction D2 so as to connect the principal surfaces 2c and 2d.

The principal surface 2d is a mounting surface, for example, a surface facing another electronic device (for example, a circuit board material or an electronic component) when the coil component 1 is mounted on the other electronic device (not illustrated). The end surfaces 2a and 2b are surfaces continuous from the mounting surface (that is, the principal surface 2d).

In the case of the forms illustrated in FIGS. 1 and 2, a length of the element body 2 in the first direction D1 is longer than a length of the element body 2 in the second direction D2 and a length of the element body 2 in the third direction D3. The length of the element body 2 in the second direction D2 is shorter than the length of the element body 2 in the third direction D3. That is, in the present embodiment, the end surfaces 2a and 2b, the principal surfaces 2c and 2d, and the side surfaces 2e and 2f have a rectangular shape. The length of the element body 2 in the second direction D2 may be equal to the length of the element body 2 in the third direction D3, or may be longer than the length of the element body 2 in the third direction D3.

Note that in the present embodiment, “equal” may be equal to a value including a slight difference or a manufacturing error in a preset range in addition to being equal. For example, when a plurality of values are included within a range of ±5% of an average value of the plurality of values, the plurality of values are defined to be equivalent.

The element body 2 is formed by laminating a plurality of element body layers (insulating layers) in the second direction D2. That is, a laminating direction of the element body 2 is the second direction D2. In the actual element body 2, the plurality of element body layers may be integrated to such an extent that boundaries between the layers cannot be visually recognized, or may be integrated so that boundaries between the layers can be visually recognized.

Each of the element body layers may be, for example, a resin layer. A material of the element body layer includes, for example, at least one selected from a liquid crystal polymer, a polyimide resin, crystalline polystyrene, an epoxy resin, an acrylic resin, a bismaleide-based resin, and a fluorine-based resin. The element body layer may contain a filler. The filler may be, for example, an inorganic filler. Examples of the inorganic filler include silica (SiO₂). Note that the element body layer may not contain a filler.

Note that the element body layer may include a magnetic material. The magnetic material of the element body layer includes, for example, a Ni—Cu—Zn ferrite material, a Ni—Cu—Zn—Mg ferrite material, or a Ni—Cu ferrite material. The magnetic material of the element body layer may contain, for example, an Fe alloy. The element body layer may contain, for example, a nonmagnetic material. The nonmagnetic material of the element body layer includes, for example, a glass ceramic material or a dielectric material.

Each of the first terminal electrode 3 and the second terminal electrode 4 is provided on the element body 2. Each of the first terminal electrode 3 and the second terminal electrode 4 is disposed on the principal surface 2d of the element body 2. The first terminal electrode 3 and the second terminal electrode 4 are provided in the element body 2 to be separated from each other in the first direction D1. Specifically, the first terminal electrode 3 is disposed on a side of the end surface 2a of the element body 2. The second terminal electrode 4 is disposed on a side of the end surface 2b of the element body 2.

Each of the first terminal electrode 3 and the second terminal electrode 4 may have, for example, a rectangular shape. Each of the first terminal electrode 3 and the second terminal electrode 4 is disposed such that each side is along the first direction D1 or the third direction D3. As illustrated in FIG. 2, the first terminal electrode 3 and the second terminal electrode 4 protrude from the principal surface 2d. That is, in the present embodiment, the respective surfaces of the first terminal electrode 3 and the second terminal electrode 4 are not flush with the principal surface 2d. The first terminal electrode 3 and the second terminal electrode 4 are made of a conductive material (for example, Cu).

Each of the first terminal electrode 3 and the second terminal electrode 4 may be provided with a plating layer (not illustrated) containing, for example, Ni, Sn, Au, or the like by electrolytic plating or non-electrolytic plating. The plating layer may include, for example, a Ni plating film containing Ni and covering the first terminal electrode 3 and the second terminal electrode 4, and an Au plating film containing Au and covering the Ni plating film.

As illustrated in FIGS. 1 and 2, the coil 5 is disposed in the element body 2. The coil 5 includes a plurality of first wiring portions 6, a plurality of second wiring portions 7, and a plurality of pillar portions 8. The coil 5 is configured by electrically connecting the first wiring portions 6, the second wiring portions 7, and the pillar portions 8. A coil axis of the coil 5 is provided along the third direction D3. The plurality of first wiring portions 6, the plurality of second wiring portions 7, and the plurality of pillar portions 8 are made of a conductive material (for example, Cu). The first wiring portions 6, the second wiring portions 7, and the pillar portions 8 are disposed apart from the end surfaces 2a and 2b, the principal surfaces 2c and 2d, and the side surfaces 2e and 2f.

Each of the first wiring portions 6 is disposed on a side of the principal surface 2c of the element body 2. Each of the first wiring portions 6 extends along the first direction D1. Each of the first wiring portions 6 connects two pillar portions 8. The first wiring portion 6 spans between the two pillar portions 8. One end portion (end portion on a side of the end surface 2a) in an extending direction of the first wiring portion 6 is connected to one end portion (end portion on a side of the principal surface 2c) of the pillar portion 8. The other end portion (end portion on a side of the end surface 2b) in the extending direction of the first wiring portion 6 is connected to one end portion (end portion on the side of the principal surface 2c) of the pillar portion 8.

Each of the second wiring portions 7 is disposed on a side of the principal surface 2d (mounting surface) of the element body 2. Each of the second wiring portions 7 extends in the first direction D1. Each of the second wiring portions 7 connects two pillar portions 8. The second wiring portion 7 spans between the two pillar portions 8. One end portion (end portion on the side of the end surface 2a) in the extending direction of the second wiring portion 7 is connected to the other end portion (end portion on a side of the principal surface 2d) of the pillar portion 8. The other end portion (end portion on the side of the end surface 2b) in the extending direction of the second wiring portion 7 is connected to the other end portion (end portion on the side of the principal surface 2d) of the pillar portion 8. The number of the plurality of second wiring portions 7 is one less than the number of the plurality of first wiring portions 6. That is, in a case where the number of the first wiring portions 6 is n, the number of the second wiring portions 7 is n-1.

The first connection conductor 10 connects the first terminal electrode 3 and one end portion of the coil 5. The first connection conductor 10 is connected to the other end portion of the pillar portion 8 of the coil 5. The first connection conductor 10 is disposed at a position close to the end surface 2a and close to the side surface 2e. The first connection conductor 10 is made of a conductive material. The first connection conductor 10 is formed of Cu, for example.

The second connection conductor 11 connects the second terminal electrode 4 and the other end portion of the coil 5. The second connection conductor 11 is connected to the other end portion of the pillar portion 8 of the coil 5. The second connection conductor 11 is disposed at a position close to the end surface 2b and close to the side surface 2f. The second connection conductor 11 is made of a conductive material. The second connection conductor 11 is formed of Cu, for example.

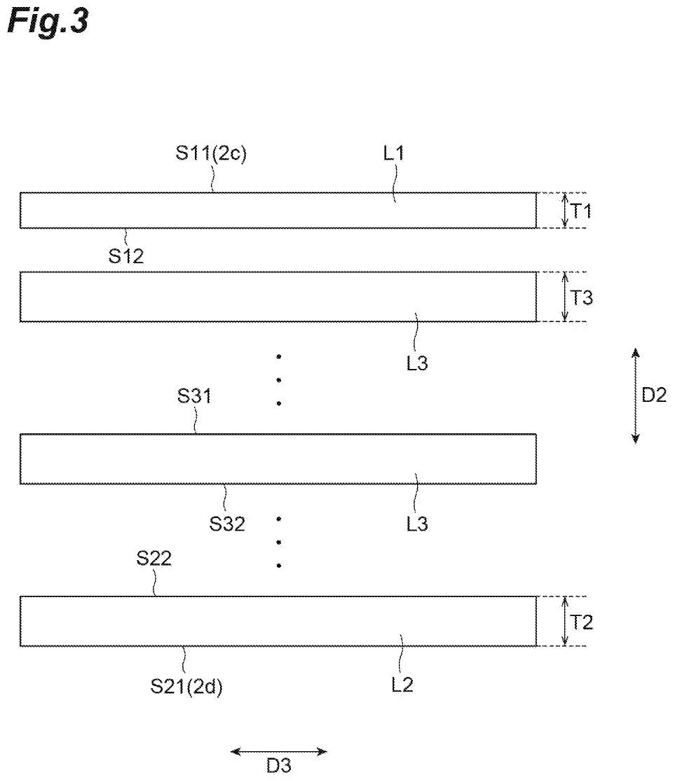

As illustrated in FIG. 3, the element body 2 includes a first element body layer (first insulating layer) L1, a second element body layer (second insulating layer) L2, and a plurality of third element body layers (third insulating layers) L3. The first element body layer L1, the second element body layer L2, and the plurality of third element body layers L3 may be formed of the same material or different materials.

The first element body layer L1 includes a first surface S11 and a second surface (facing surface) S12. The first surface S11 and the second surface S12 face each other in the second direction D2. The first surface S11 is a surface constituting the principal surface 2c. The second element body layer L2 includes a first surface S21 and a second surface S22. The first surface S21 and the second surface S22 face each other in the second direction D2. The first surface S21 is a surface constituting the principal surface 2d. The third element body layers L3 are disposed between the first element body layer L1 and the second element body layer L2. Each of the third element body layers L3 includes a first surface S31 and a second surface S32. The first surface S31 and the second surface S32 face each other in the second direction D2.

In the present embodiment, the first element body layer L1, the second element body layer L2, and the third element body layer L3 have different thicknesses in the second direction D2. A thickness T1 of the first element body layer L1 is thinner than a thickness T2 of the second element body layer L2 and a thickness T3 of the third element body layer L3. In other words, the thickness T2 of the second element body layer L2 and the thickness T3 of the third element body layer L3 are thicker than the thickness T1 of the first element body layer L1. The thickness T2 of the second element body layer L2 is equal to the thickness T3 of the third element body layer L3. The thickness T1 of the first element body layer L1 is a distance between the first surface S11 and the second surface S12 in the second direction D2. The thickness T2 of the second element body layer L2 is a distance between the first surface S21 and the second surface S22 in the second direction D2. The thickness T3 of the third element body layer L3 is a distance between the first surface S31 and the second surface S32 in the second direction D2.

A surface roughness (arithmetic average roughness) Ra (Hereinafter, it may be referred to as Ra12.) of the second surface S12 of the first element body layer L1 is smaller than a surface roughness (may be described as Ra21, Ra22, Ra31, and Ra32, respectively.) of the first surface S21 and the second surface S22 of the second element body layer L2 and the first surface S31 and the second surface S32 of the third element body layer L3. In other words, the surface roughness (Ra21, Ra22, Ra31, and Ra32) of the first surface S21 and the second surface S22 of the second element body layer L2 and the first surface S31 and the second surface S32 of the third element body layer L3 are larger than the surface roughness (Ra12) of the second surface S12 of the first element body layer L1.

In the present embodiment, the second surface S12 of the first element body layer L1 is, for example, a non-polished surface. Note that the first surface S11 of the first element body layer L1 may be a non-polished surface. The first surface S21 of the second element body layer L2 is, for example, a polished surface. The second surface S22 of the second element body layer L2 may be, for example, a non-polished surface. The first surface S31 of the third element body layer L3 may be, for example, a non-polished surface. The second surface

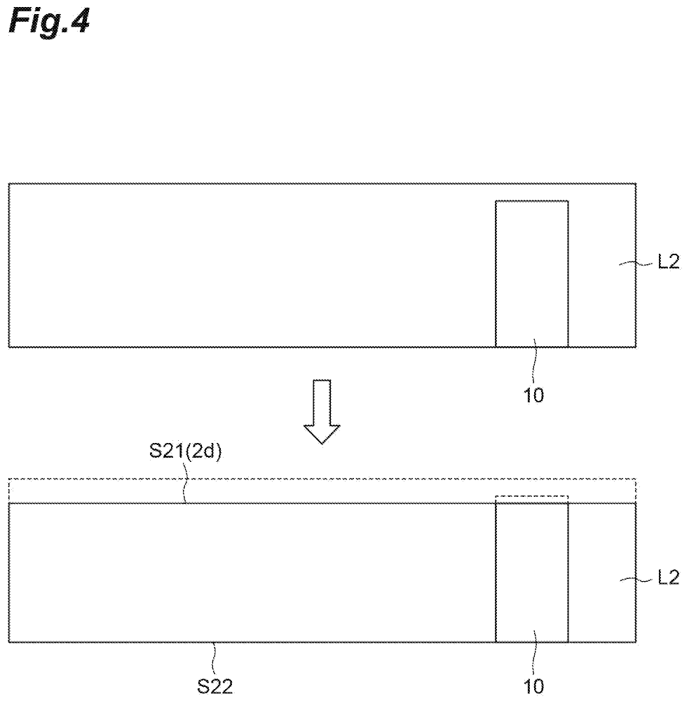

S32 of the third element body layer L3 is, for example, a polished surface. The polished surface is formed by, for example, grind polishing. FIG. 4 is a diagram illustrating an example of a method of forming a polished surface. As illustrated in FIG. 4, the first surface S21, which is a polished surface, is formed by polishing a part (upper portion) of the second element body layer L2. By such polishing, for example, the surface of the element body layer is scraped, so that the surface roughness becomes rough as compared with the non-polished resin surface. Note that the formation of the polished surface is not limited to grind polishing, and for example, the surface roughness may be adjusted by plasma treatment as post-treatment.

The coil component 1 can be manufactured, for example, as follows. The element body 2 can be formed by laminating sheets constituting the element body layer. The coil 5 (first wiring portion 6, second wiring portion 7, and pillar portion 8), the first connection conductor 10, and the second connection conductor 11 can be manufactured using a photolithography method. The “photolithography method” is not limited to a type of mask or the like as long as a layer to be processed containing a photosensitive material is processed into a desired pattern by exposing and developing the layer.

First, in a sheet constituting the first element body layer L1, a conductor constituting the first wiring portion 6 is formed on a surface corresponding to the second surface S12 of the first element body layer L1 by the photolithography method. As a result, the first wiring portion 6 is in contact with (abuts on) the second surface S12 of the first element body layer L1, and is formed along the second surface S12 of the first element body layer L1. Note that since the second surface S12 of the first element body layer L1 is not polished, the roughness (Ra12) of the resin surface is smaller than the roughness (for example, Ra21, Ra22, Ra31, and Ra32) of the polished surfaces of the second element body layer L2 and the third element body layer L3 to be described later.

After the first wiring portion 6 is formed, sheets constituting the third element body layer L3 are laminated. Subsequently, the sheet is polished by grind polishing to expose the conductors and planarize the sheets. By such polishing, the surface of the third element body layer L3 is scraped, so that the surface roughness becomes rough as compared with the non-polished resin surface.

Subsequently, after a conductor constituting the pillar portion 8 is formed by the photolithography method, sheets constituting the third element body layer L3 are laminated. Subsequently, the sheet is polished by grind polishing to expose the conductors and planarize the sheets. By repeating this process a predetermined number of times, the pillar portion 8 is formed.

Subsequently, after a conductor constituting the second wiring portion 7 is formed by the photolithography method, sheets constituting the third element body layer L3 are laminated. Subsequently, the sheet is polished by grind polishing to expose the conductors and planarize the sheets.

Subsequently, after a conductor constituting the first connection conductor 10 (second connection conductor 11) is formed by the photolithography method, sheets constituting the second element body layer L2 are laminated. Subsequently, the sheet is polished by grind polishing to expose the conductors and planarize the sheets. By polishing, a part of a filler contained in the sheets may fall off, and a recess may be formed in the principal surface 2d. Then, the first terminal electrode 3 and the second terminal electrode 4 are formed. As described above, the coil component 1 is obtained.

As described above, in the coil component 1 according to the present embodiment, the surface roughness (Ra12) of the second surface S12 of the first element body layer L1 is smaller than the surface roughness (Ra21 and Ra22) of the first surface S21 and the second surface S22 of the second element body layer L2 and the surface roughness (Ra31 and Ra32) of the first surface S31 and the second surface S32 of the third element body layer L3. On the second surface S12, the first wiring portion 6 is disposed along the second surface S12. As a result, in the coil component 1, the surface (the surface in contact with the second surface S12) of the first wiring portion 6 can be made flat (unevenness can be reduced). Accordingly, in the coil component 1, the resistance in the first wiring portion 6 can be reduced. Therefore, in the coil component 1, characteristics in a high frequency band can be improved. In particular, by planarizing the surface of the first wiring portion 6 disposed at a position away from the principal surface 2d on which the first terminal electrode 3 and the second terminal electrode 4 are disposed, the influence of a stray capacitance formed between the first terminal electrode 3 and the second terminal electrode 4 is small, so that the characteristics can be effectively improved. As described above, in the coil component 1, the frequency characteristics can be improved.

In the coil component 1 according to the present embodiment, the surface roughness (Ra12) of the second surface S12 of the first element body layer L1 is smaller than the surface roughness (Ra21) of the first surface S21 (principal surface 2d) of the second element body layer L2. In other words, the surface roughness (Ra21) of the first surface S21 (principal surface 2d) of the second element body layer L2 is larger than the surface roughness (Ra12) of the second surface S12 of the first element body layer L1. In this configuration, since unevenness is formed on the principal surface 2d on which the first terminal electrode 3 and the second terminal electrode 4 are disposed, the joint strength between the element body 2 and the first terminal electrode 3 and the second terminal electrode 4 can be improved by the anchor effect. Therefore, peeling of the first terminal electrode 3 and the second terminal electrode 4 can be suppressed.

In the coil component 1 according to the present embodiment, the thickness T1 of the first element body layer L1 in the second direction D2 is thinner than the thickness T2 of the second element body layer L2. With this configuration, the height of the coil component 1 can be reduced. Furthermore, by making the thickness T2 of the second element body layer L2 constituting the principal surface 2d on which the first terminal electrode 3 and the second terminal electrode 4 are disposed thicker than the thickness T1 of the first element body layer L1, a stray capacitance formed between the first terminal electrode 3 and the second terminal electrode 4 and the second wiring portion 7 can be reduced.

In the coil component 1 according to the present embodiment, the second element body layer L2 includes the resin and the filler. The first surface S21 (principal surface 2d) of the second element body layer L2 is a polished surface formed by polishing. The filler is exposed on at least a part of the first surface S21 (principal surface 2d). In this way, in the configuration in which the filler is exposed on the first surface S21 (principal surface 2d), a part of the filler falls off at the time of polishing, and a recess can be formed on the first surface S21 (principal surface 2d). In this manner, since the recess is formed on the first surface S21 (principal surface 2d) by polishing, the surface of the first surface S21 (principal surface 2d) can be roughened. Therefore, it is possible to improve the joint strength between the element body 2 and the first terminal electrode 3 and the second terminal electrode 4 by the anchor effect.

Although the embodiment of the present disclosure have been described above, the present disclosure is not necessarily limited to the above-described embodiment, and various modifications can be made without departing from the gist thereof.

In the above embodiment, the configuration of the coil 5 is not limited to the form illustrated in FIGS. 1 and 2.

In the above embodiment, a mode in which the thickness T1 of the first element body layer L1 is thinner than the thickness T2 of the second element body layer L2 and the thickness T3 of the third element body layer L3 has been described as an example. However, the thickness T1 of the first element body layer L1 may be equal to the thickness T2 of the second element body layer L2 and the thickness T3 of the third element body layer L3, or may be larger than the thickness T2 of the second element body layer L2 and the thickness T3 of the third element body layer L3.

What is claimed is:

1. A coil component comprising:
an element body formed by laminating a plurality of insulating layers, the element body including a mounting surface and a principal surface facing the mounting surface;
a pair of terminal electrodes disposed on the mounting surface of the element body; and
a coil disposed in the element body and electrically connected to the pair of terminal electrodes,
wherein the coil includes a first wiring portion disposed on a side of the principal surface, a second wiring portion disposed on a side of the mounting surface, and a connection portion extending in a facing direction of the mounting surface and the principal surface and connecting the first wiring portion and the second wiring portion,
the plurality of insulating layers includes
a first insulating layer constituting the principal surface, the first insulating layer including the principal surface and a facing surface facing the principal surface, the first wiring portion being disposed along the facing surface,
a second insulating layer constituting the mounting surface, and
one or a plurality of third insulating layers disposed between the first insulating layer and the second insulating layer, and
a surface roughness of the facing surface of the first insulating layer is smaller than a surface roughness of each of surfaces of the second insulating layer and the third insulating layer.

2. The coil component according to claim 1, wherein the surface roughness of the facing surface of the first insulating layer is smaller than a surface roughness of the mounting surface of the second insulating layer.

3. The coil component according to claim 1, wherein a thickness of the first insulating layer in the facing direction of the mounting surface and the principal surface is thinner than a thickness of the second insulating layer.

4. The coil component according to claim 1, wherein
the second insulating layer includes a resin and a filler,
the mounting surface is a polished surface formed by polishing, and
the filler is exposed on at least a part of the mounting surface.

5. A method of manufacturing a coil component, the coil component including:
an element body formed by laminating a plurality of insulating layers, the element body including a mounting surface and a principal surface facing the mounting surface;
a pair of terminal electrodes disposed on the mounting surface of the element body; and
a coil disposed in the element body and electrically connected to the pair of terminal electrodes,
wherein the coil includes a first wiring portion disposed on a side of the principal surface, a second wiring portion disposed on a side of the mounting surface, and a connection portion extending in a facing direction of the mounting surface and the principal surface and connecting the first wiring portion and the second wiring portion, and
the plurality of insulating layers includes
a first insulating layer constituting the principal surface, the first insulating layer including the principal surface and a facing surface facing the principal surface, the first wiring portion being disposed along the facing surface,
a second insulating layer constituting the mounting surface, and
one or a plurality of third insulating layers disposed between the first insulating layer and the second insulating layer,
the method comprising
making a surface roughness of the facing surface of the first insulating layer smaller than a surface roughness of each of surfaces of the second insulating layer and the third insulating layer.
